(19) United States
(12) Patent Application Publication
(10) Pub. No.: US 2007/0233827 A1
(43) Pub. Date: Oct. 4, 2007

(54) AD HOC DISTRIBUTED RESOURCE COORDINATION FOR A WIRELESS GRID

(76) Inventor: Lee W. McKnight, Manlius, NY (US)

Correspondence Address: BOND, SCHOENECK & KING, PLLC, ONE LINCOLN CENTER, SYRACUSE, NY, 13202-1355, US

(21) Appl. No.: 11/277,827

(22) Filed: Mar. 29, 2006

(51) Int. Cl. G06F 15/173

(52) U.S. Cl. 709/223

(57) ABSTRACT

A system and method for the ad hoc distribution of resources within a wireless grid for coordinating dynamic resource sharing. The architecture of the present invention comprises four primary modules: a resource descriptor that specifies the language for defining the resources; a service agent that facilitates interactions between the requesting devices and available resources; a resource manager that defines the methods by which the resources are shared, used, managed, and paid for; and a session manager that handles the establishment of sessions between mobile devices in a manner that does not require a centralized name service or directory. The combination of these modules allow for the rapid development of applications based on the wireless grid technologies using these common building blocks.

### BACKGROUND OF THE INVENTION

1. Field of Invention

The present invention relates to ad hoc networks and, more specifically, to a system and method for resource sharing within a wireless grid.

2. Description of Prior Art

The sharing of computational resources by direct exchange between computers (peer-to-peer architecture) has been in existence for more than thirty years. Grid computing builds on the concept of peer-to-peer computing in order to define coordinated computational resource sharing among devices for high performance computing. Efforts are currently underway towards a global standardization for the field of grid computing. For example the Globus Project is focused on standardization and best practices within the field of grid computing. A de facto standard, the Globus Toolkit, provides specifications for grid computing.

Current grid implementations focus on sharing of computational resources for high-end computing across disparate but known administrative domains. These resources typically include computers, software, databases, other hardware such as printers, and are usually focused at present on applications within science and engineering.

Wireless devices can offer ubiquitous access to desired resources. These wireless mobile devices however typically face a number of constraints such as (a) limited battery life, therefore power consumption must be low; (b) processing power is not extensive; (c) constrained physical interface; and (d) limited bandwidth access. These devices also offer new capabilities such as distributed I/O, mobility and nomadicity. Collaboration for the dynamic sharing of resources among heterogeneous mobile, wireless, and wired (and/or fixed) devices therefore needs to be addressed.

3. Objects and Advantages

It is a principal object and advantage of the present invention to provide a system and method for resource sharing within a wireless grid.

It is an additional object and advantage of the present invention to provide a system and method for forming ad hoc wireless networks of devices.

It is a further object and advantage of the present invention to provide a system and method for supporting interactions between devices constrained by power and processing capabilities.

Other objects and advantages of the present invention will in part be obvious, and in part appear hereinafter.

### SUMMARY OF THE INVENTION

In accordance with the foregoing objects and advantages, the present invention comprises a system and method for the ad hoc distribution of resources within a wireless grid for coordinating dynamic resource sharing. The architecture of the present invention comprises four primary modules: a resource descriptor that specifies the language for defining the resources; a service agent that facilitates interactions between the requesting devices and available resources; a resource manager that defines the methods by which the resources are shared, used, managed, and paid for; and a session manager that handles the establishment of sessions between mobile devices in a manner that does not require a centralized name service or directory. The combination of these modules allow for the rapid development of applications based on the wireless grid technologies using these common building blocks.

### BRIEF DESCRIPTION OF THE DRAWINGS

The present invention will be more fully understood and appreciated by reading the following Detailed Description in conjunction with the accompanying drawings, in which:

FIG. 1 is a high-level schematic of the architecture of the present invention.

FIG. 2 is a high-level schematic of resource description according to the present invention.

FIG. 3 is a high-level schematic of the implementation of a resource according to the present invention.

FIG. 4 is a high-level schematic of the implementation of a client according to the present invention.

FIG. 5 is a high-level schematic of a network request according to the present invention.

FIG. 6 is a high-level schematic of a broadcast query between enabled nodes according to the present invention.

FIG. 7 is a high-level schematic of an open session between enabled nodes according to the present invention.

FIG. 8 is a high-level schematic of a multicast query according to the present invention.

FIG. 9 is a high-level schematic of interface control according to the present invention.

FIG. 10 is a high-level schematic of the instantiation of a resource according to the present invention.

### DETAILED DESCRIPTION

Following is a glossary of terms used in the present application:

The term “Ad-Hoc Distributed Resource Coordination (ADRC)” refers to the system and method for resource sharing within and across wired and wireless grids according to the present invention.

The term “ad hoc network” refers to local area network where devices communicate directly with each other without need of a centralized point of administration or control. The mobile devices form or are a part of the ad hoc network if within close proximity of each other.

The term “grid” refers to grid computing which builds on the concepts of peer-to-peer computing to coordinate computational resource sharing among groups of computing devices.

The term “interface definition” refers to a definition for actions and attributes that an object may have. This can be used to represent the interface for a resource that is to be shared within the ADRC framework.

The term “marshalling” refers to the process of converting native programming language data types to a format suitable for transmission across a network; the term “unmarshalling” is the conversion of data received over a network from its on-the-wire representation to data types appropriate to the receiving application.

The term “mobile devices” refers to a class of small computing devices that are portable and can provide communication and/or computational services such as handhelds, laptops, tablets, mobile phones, and personal digital assistants (PDAs). Smaller devices such as portable sensors may also be reached across sensor networks, and have their resources coordinated and shared by the ADRC architecture.

The term “nomadic devices” refers to devices that may be similar to those listed above, with the emphasis not on connectivity while literally in motion, but rather when the user is at various fixed but possibly varying locations. For example using a notebook computer at a wi-fi hotspot could be seen as use of a nomadic device.

The term “object” refers to a self-contained piece of software that is comprised of attributes and methods which serve a related purpose. One example of such an object is a list; the attributes would be the elements of the list, and the operations or procedures would be for example add, remove, and sort.

The term “resource” refers to an entity within the ADRC architecture that is shared with other applications; also called a service in the case of software. The resource has an interface that closely resembles the way that the hosting computer would interface with that resource. If the hosting computer interfaces with a resource in a non-standard or proprietary way, the resource interface may be made more standard so as to promote interoperability. In the context of this document, the term resource is used to describe both hardware and software (services).

The term “resource base” refers to an object that contains functionality common to all ADRC resources. All ADRC Resource have a Type, Name, Parameters, and Owner.

The term “resource description language” (RDL) refers not to a specific language, but any language that fulfills or exceeds the requirements of the present invention. This language is not used directly by running software, but instead is sent through a parser which generates code used by an application developer.

The term “resource descriptor” refers to the Type, Name, Parameters, and Owner of a Resource.

The term “resource factory” refers to an object-oriented software design pattern that creates the Resource Implementation.

The term “resource implementation” has attributes and operations that are defined by the Resource Descriptor that are passed into the Resource Factory.

The term “resource sharing protocol” refers to the management of a specific resource.

The term “service agent” refers to a method by which devices in the network can publish the resources that they wish to advertise on their network for use by other member devices of the network.

The term “session manager” refers to an interface whereby messages are passed from external devices to the Resource Manager of the host device.

The term “skeleton code” refers to source code generated by a parser that forms the basis of a software interface to that resource on the server-side of a client-server relationship. The Skeleton Code handles the marshalling of operation replies, as well as the unmarshalling of operation requests. The generated source code is the result of parsing a resource description written in a specific resource description language.

The term “stub code” refers to source code generated by a parser that forms the basis of a software interface to that resource on the client-side of a client-server relationship. This code provides the same interface as the skeleton code, and handles marshalling and unmarshalling of operation requests and replies.

The term “wired or wireline connections” refers to connections to wired or wireless telecommunication networks for data, voice, video information transmission.

The underlying ADRC architecture of the present invention handles four important tasks, namely, defining a language for describing resources, handling the publishing and discovery of resources, handling the establishment of sessions between mobile devices in a manner that does not require a centralized name service or directory, and defining access to and management of the resources.

The language of the present invention describes both the functional interface for a resource/service as well as meta-data about that resource. This meta-data can contain (but is not limited to) information about power consumption, battery charge, CPU speed, network connection and bandwidth, cost, version numbering, physical and/or geographic location, security policies, and quality of service policies. This meta-data can also detail the physical characteristics of a device's human-computer interfaces, including (but not limited to) screen size, screen resolution, number of colors supported, keypad type (e.g., full keyboard, Blackberry-type mini keyboard, Palm Graffiti, electronic keypad, and phone keypad), and interaction modality (e.g., mouse-driven, pen-driven, and button-driven). The language for defining resources may be based on an already existing language (for example the Web Service Description Language, or the Globus Resource Definition Language) with extensions that handle provisioning and resource specific constraints.

The present invention may use ZeroConf (www.zeroconf.org) to facilitate resource advertising and discovery within the network. It is an open standard and is guided by the Internet Engineering Task Force (IETF). The present invention may also be used with other protocols, such as the Service Location Protocol (SLP), or any future protocols. The architecture of the present invention defines an interface for application developers, which requires a name or identifier of the resource as well as some other defining information such as the type of the resource, its location, and other meta data. This information gets passed from the ADRC framework down to a specific discovery implementation.

A service name is a unique identifier within a certain domain. The name of a service can help differentiate between services of the same type in a network. An example of a service name might be “Joe's AudioInputResource” or “Public SpellCheckService.” A service type is a specific moniker used to represent a resource/service. An example would be AudioInputResource or SpellCheckService. The service type is a general identifier used when searching for a kind of resource/service; the service can be a subscribed service that is users must specifically be authenticated to utilize this resource, or can be a public resource. The location of a service can be defined in both relative and absolute terms. A relative location within an ad-hoc network can be described using a local moniker or other method. An absolute location is in defined as an address that could be used from any Internet connection to find the service. Service meta-data can be almost anything, and may can contain (but is not limited to) data about security policies, cost and/or provisioning information.

The architecture of the present invention also provides an interface for passing messages between devices and underlying resources. This interface communicates with lower level protocols that can be defined on a per application basis. The actual message passing implementation may differ from application to application based on requirements specific to a given resource. The message-passing interface is such that application developers can “plug-in” different protocols to be used at both the session layer and the transport layer. The present invention may use the Block Extensible Exchange Protocol (BEEP) as the session level protocol (which in turn uses TCP/IP as the transport layer protocol), but applications do not have to be aware of the specific details of how BEEP or TCP/IP works.

The session layer protocol handles establishing sessions between resources, handling of session layer security policies, and passing of messages between endpoints of a connection. The chosen transport level protocol shall handle the aspects of byte-ordering, connection handshakes, transport level security policy, and passing of messages between nodes on the network.

The focus of the interface of the present invention is to create a mechanism for building a custom protocol stack on a per resource basis. In this manner, a resource that requires continuous throughput, for example audio or video data streams, can use a real time streaming protocol such as Real-time Transport Protocol (RTP) over User Datagram Protocol (UDP), while a resource that requires interoperability with web services can use the Simple Object Access Protocol (SOAP) over TCP/IP.

The resource sharing protocols of the present invention defines manner in which devices may gain access to the network resources. The protocols thus allow users to gain specific information about the available resource such as the cost of that resource or service, and the status of the resource. Users can then gain access to the resources and submit requests for fulfillment of a particular service by that resource. The resource sharing protocols may allow or require secure authentication and authorization of devices for accessing the resource through the session manager or interface of the present invention.

The protocols also inform the requesting device of the status of the resource during execution of the service, and provide notification when the service request has been completed. The protocols are therefore responsible for monitoring the status of a particular service request, and handling quality of service (QoS) issues in the fulfillment of that service.

The resource sharing protocols may also describe the payment mechanisms for the available resource. For example users may store credit card information for dynamic payment for services or a ‘token exchange’ system whereby a requesting device provides tokens to devices that can be exchanged for future use of a resource available to that device. Currently the usual assumption within a network is that sharing of resources is provided at no cost to other devices addressable by that network.

When the various aspects of the architecture are implemented, the system and method of the present invention allows for rapid development of future applications based on the wireless grid technologies using these common building blocks that handle the problems of this class of applications. The processes for publishing and accessing a new resource all for writing a resource description then running it through a parser which creates source code to be used in to handle the creation and passing of messages intended for specific resources. The resource description is also directly used for determining what information gets published to the network for other people to see when they search. A developer would then take the source code output created and write code to handle the implementation behind the functional interface. Compiling and running this code will provide a working resource that other people can access. Similarly, a developer could use the code to create a program to access the defined resource.

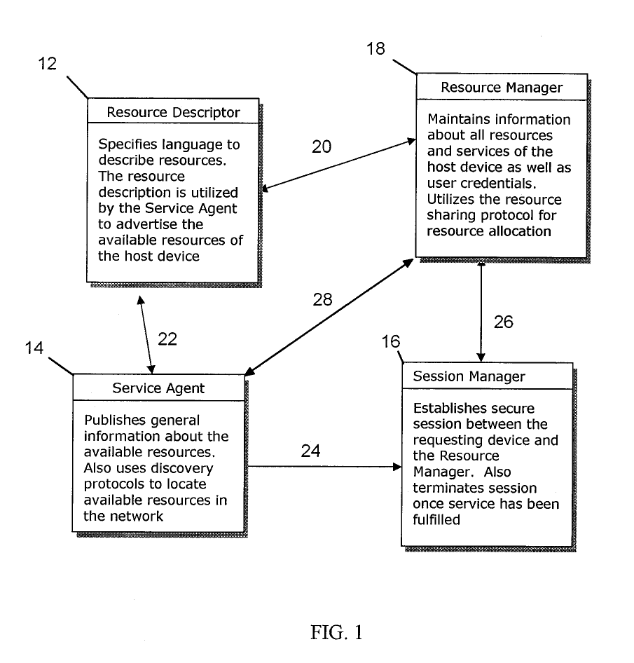

Referring now to the drawings, wherein like numeral refer to like parts throughout, there is seen in FIG. 1 a high-level schematic of the architecture of ADRC 10 of the present invention. ADRC 10 is relevant for wireless mobile devices and particularly appropriate for interactions including several mobile and nomadic devices that are constrained by resources such as power and processing capabilities. ADRC 10 comprises four primary modules that define the architecture of the system; a Resource Descriptor 12, a Service Agent 14, a Session Manager 16, and a Resource Manager 18.

Resource Descriptor 12 specifies the resource interface and its attributes and uses a specific language to describe the resource or service. The resource description includes information about the resource such as its name, type, owner, status and location.

Service Agent 14 describes the method by which resources are discovered and published in the network. Service Agent 14 interfaces with the Resource Manager 18 in order to obtain updated information on a specific resource. Service Agent 14 also utilizes a discovery protocol to obtain information on other resources in the network, and query protocols for requesting information from a particular device. If a particular resource is being requested by another device on the network, then Session Manager 16 of the host device initiates a secure session between Resource Manager 18 and the requesting device in order to obtain information about the specific resource and execute the desired service. Service Agent 14 of the host device publishes the resource information on the network.

Session Manager 16 handles the establishment of sessions between mobile devices in a way that does not require a centralized name service or directory.

Resource Manager 18 defines the method whereby resources are shared, used, managed, and paid for. Resource Manager 18 is also responsible for authentication and authorization of the requesting device, and also handles payment of the requested service. Resource Manager 18 also maintains user information, such as user credentials (for example username and password), for subscribed services.

As seen in FIG. 1, Resource Descriptor 12 communicates with Resource Manager 18 along node 20 to obtain detailed information of a resource using the specified procedures/functions. Information about the specific resource is then communicated via node 22 to Service Agent 14 by Resource Descriptor 12. This information may include the name of the resource, its location, and type. Service Agent 14 uses the initiated sessions for direct queries between its host device and another device. Through nodes 20 and 24, specific information may be obtained about a service, such as its status and cost, and the service may be executed and paid for. Resource Manager 18, through the initiated session, can obtain information about the requesting device that may be needed to make access control decisions.

Resource Descriptor 12 requires a language for describing data types. No specific language is required by ADRC, but there are functional requirements for the given language. For instance, the language must be able to handle primitive data types such as Integer numbers, Bit Strings, Booleans, Floating Point numbers, Null Data, and Strings of Text. The language must provide a notation for describing arrays of primitive data types. An array is an ordered sequence of data and each array may have zero or more elements. The language must also provide a notation for describing sets of primitive data types. A set is an unordered sequence of data. Each set may have zero or more elements. The language must further provide a notation for describing data structures built as the composition of defined primitives. The composition shall also be able to handle optional data structure elements. The language must additionally provide a notation for describing operations. This notation, if used, should be able to define a named operation that takes zero or more input values and produces zero or one output values. Both the input values and output value may be a user defined data structure that is composed from data primitives. Finally, the language must provide a mapping from itself to one or more specific programming languages (Java, C/C++, etc.). This mapping shall be achieved by the use of a parser that takes, as input, a language file and produces, as output, skeleton code and stub code for use by application developers. The skeleton and stub code shall be output in a specific programming language. The parser may also produce other source code files that are responsible for marshalling and unmarshalling of data structures and messages for transport over a network. The marshalling of a message produces machine-independent formats for transference of the message. The unmarshalling of a message produces a data structure that can be manipulated from within software running on the machine that does the unmarshalling; it may be machine dependent in this regard.

Three examples of such languages that could be used as a Resource Descriptor Language (RDL) are WSDL, ASN.1, or XML Schema. The Abstract Syntax Notation One (ASN.1) is an International Telecommunication Union (ITU) industry standard that is used to define data structures used in protocol development. XML Schemas are used within XML-RPC based environments. The XML Schema defines message types and operations that can be handled by an XML-RPC based service. WSDL is used specifically for definition of interfaces used in Web Service environments.

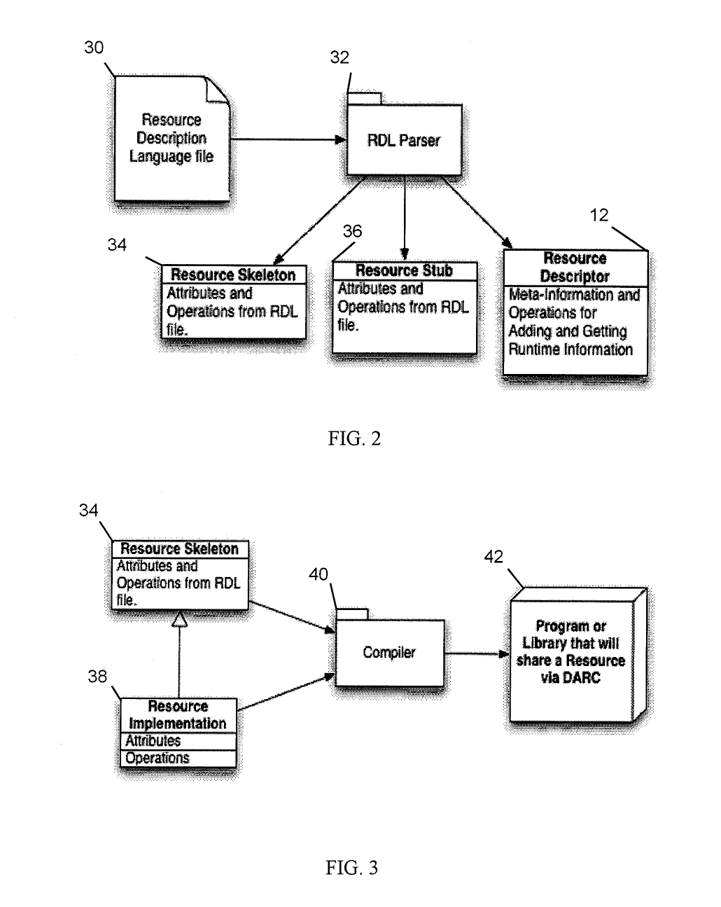

Referring to FIG. 2, a Resource Definition Language (RDL) file 30 is used to produce Resource Skeleton 34, Resource Stub 36, and Resource Descriptor 12. An application developer first writes an RDL file 30 containing the definition for the interface to the resource. RDL file 30 also includes (directly or indirectly) the definitions for any data structures used in the definition of the resource interface. Next, the application developer executes a parser 32, using the RDL file 30 as an input to the parser. The execution of this parser produces skeleton code for Resource Skeleton 34, stub code for Resource Stub 36, and Resource Descriptor 12 that the application developer will use.

Referring to FIG. 3, a resource is implemented using a Resource Implementation 38 to extend the skeleton code of Resource Skeleton 34 to add functionality specific to the resource being implemented. An application developer then compiles both the generated skeleton code of Resource Skeleton 34 and the additional source code that extends the skeleton code. This step produces a library or application 42 that can run and share a given resource with other applications over a network connection.

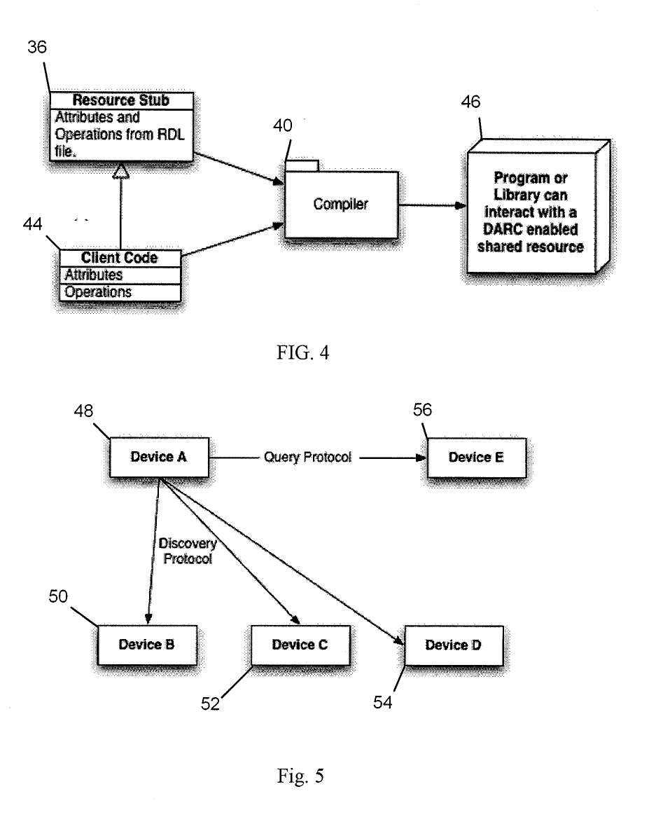

Referring to FIG. 4, a client of a Resource is software that is capable of connecting to a shared resource and using the operational interface of that resource. To implement a client, an application developer writes source code based on the Client Code 44 that uses the stub code of Resource Stub 36 to interact with the published resource. A developer then complies the stub code and written source code using a compiler 40 to output a library of application 46 that can run and interact a shared resource over a network connection.

Resource Descriptor 12 may also be used in publishing and discovery of resources within a Wireless Grid and in the creation of protocol bridges that connect two different protocols. For example, an XML Schema—ASN.1 bridge or a WSDL—IIOP bridge.

Service Agent 14 provides a method whereby resources are advertised or published in the grid, and are discovered by other devices within the grid. The Service Agent must offer a method for the publishing of resources that have been defined by Resource Descriptor 12. Service Agent 14 can use ad-hoc and static discovery protocols for locating other devices within the network. Service Agent 14 discovers a particular resource by using a number of criteria for example the service name or identifier (particularly if already known), by the resource type, or by the resource location. Service Agent 14 protocols must take into consideration the capabilities of heterogeneous devices within the network which may vary according to storage space, processing power, memory, screen size, etc. Service Agent 14 must provide meta-data concerning its host device and available resources, such as location and type of the resource of service, and information about resources is retrieved from Resource Descriptor 12. Service Agent 14 must also accommodate changes in the parameters of the host resources, and update those changes when advertising that resource. Service Agent 14 must be able to locate the best or most appropriate available resource according to the specified request parameters. The protocols must also allow for the dynamic addition and removal of devices within the network. Service Agent 14 should further accommodate multicasting of a device request on the network. Information about the particular resources must be provided to network devices that are subscribed to the service on the host device or as a result of a query. Service Agent 14 must differentiate between subscribers to specific resources of the host device, and general queries.

An example Service Agent 14 uses ZeroConf to facilitate discovery of resources and services within the grid. However, there is nothing that limits the architecture of ARDC 10 to ZeroConf, as other protocols such as the Service Location Protocol (SLP), or other future protocols, can also be utilized.

Service Agent 14 utilizes a discovery protocol (such as ZeroConf protocols) to retrieve information about the services in the network. Referring to FIG. 5, Service Agent 14 of a device 48 may send out a general request to the network in order to obtain information about available resources or services (as provided by other devices in the network, such as devices 50, 52, and 54). Device 48 may also query a specific service, for example a service provided by device 56, to which device 48 is subscribed. The only information which is registered by Service Agent 14 for each device is the name of the resource, and the type of the resource.

The design of a user interface for devices within the wireless grid is geared to providing user interface developers with a high level description language and a user interface management system for describing and programming reality-based user interfaces given the uncertainty about the input-output devices they will employ. The proposed implementation of user interfaces within the wireless grid environment we have termed reality-based interfaces. This connotes alternative interaction styles for applications currently available in the Grid, and will serve as a conduit for a new generation of applications which rely on real-world interactions. Reality-based interfaces are characterized by: a combination of continuous and discrete interaction; multi user concurrent interaction via several parallel devices; two parallel output channels—a digital channel (e.g., sound and graphics) and a movement channel (e.g., movement or a shadow); foreground activities (i.e., intentional interaction actions) combined with a background sensing (i.e., sensing and inferring of naturally occurring user activity). Most current user interface description languages and software tools are based on discrete, serial, event-based models which are unsuitable for directly addressing these properties.

Session Manager 16 is used to establish a session between two devices implementing the architecture of ADRC 10. The created session is used to pass messages between devices that can be used to interact with components of the ADRC Architecture that may be on other devices, and that send messages to specific Resources located on other devices.

To establish a session between two devices, an application must have an address of another machine to which it will connect and a set of credentials to give to the other machine. The address used to connect to may be a hostname and port number (as used in most TCP/IP based applications) or it may be any network specific address type, e.g., Bluetooth address, Anonymous Peer-to-Peer address, etc. The address that a peer has can be extended to reference a specific resource or ADRC Architecture component.

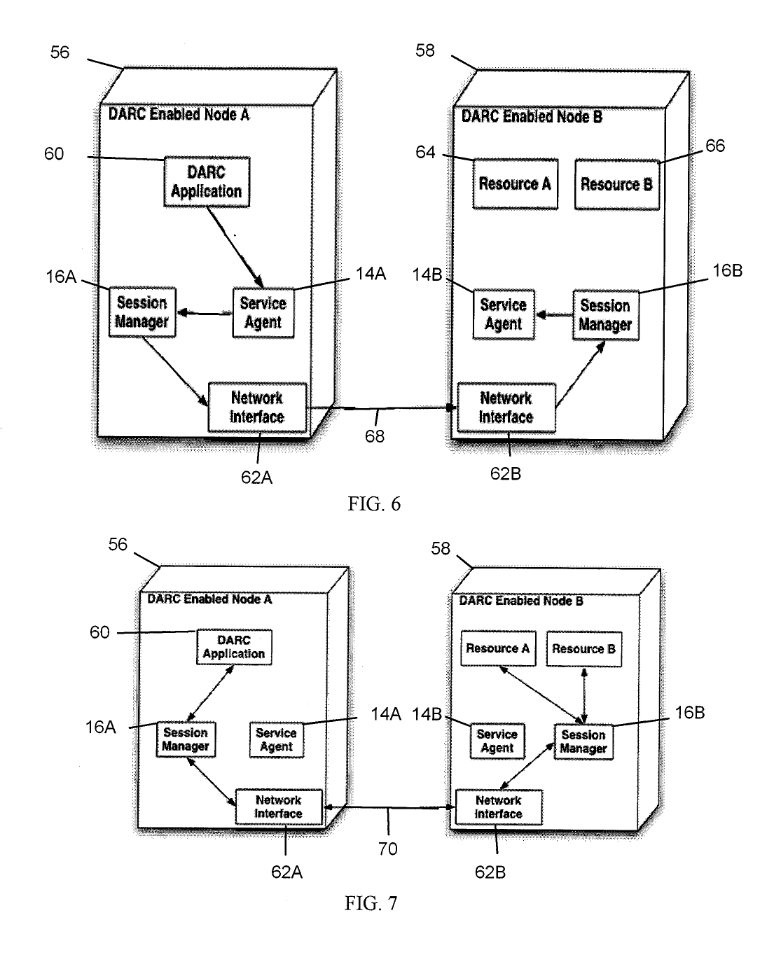

Referring to FIG. 6, an ADRC 10 running on computer 56 (referred to as a DARC Enabled Node), has knowledge of computer 58 from an initial broadcast query. If computer 56 would like to do a specific query on computer 58 that does not get broadcasted to the rest of the network, the following steps are taken. First, ADRC Application 60 notifies its Service Agent 14A that it has a query to be sent to a specific machine. Second, the Service Agent 14A sends the query data to Session Manager 16A since it is not a broadcast request. Third, Session Manager 16A checks to see if there is already a session established between computer 56 and computer 58. If there is, Session Manager 16A sends a query message over that established session 68 via a network interface 62A. If there is not, it establishes a session 68 from computer 56 to computer 58 and then sends the query message to computer 58 over the recently established session via network interface 62A.

Referring to FIG. 7, multiplexing during an open session between two ADRC nodes may be accomplished. If an application on computer 56 wishes to use yet another resource on computer 58, it can re-use the session that already exists. This session has associated with it a set of credentials based upon the user on computer 56. These credentials can be extended to include application specific credentials that are unique to each application that uses the established session between computer 56 and computer 58.

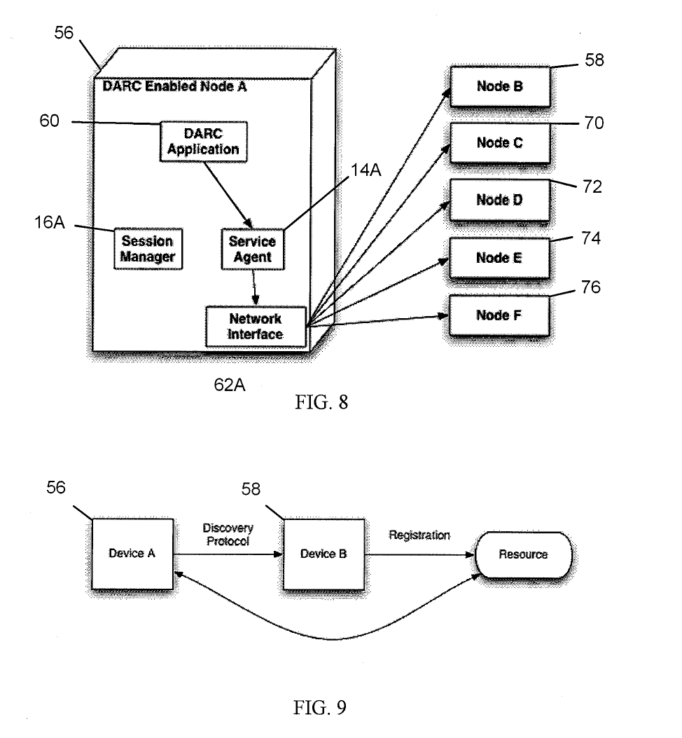

Referring to FIG. 8, a multicast query does not use Session Manager 16A because there is no session being created or used, and instead a query is sent out by Service Agent 14A over a multicast session. This query gets sent simultaneously to everybody subscribed to the multicast group, such as Node B 58, Node C 70, Node D 72, Node E 74 and Node F 76. The definition of multicast, as used herein, is based on multicast within the scope of the Internet Protocol (IP). There is no reason, however, that ADRC 10 cannot utilize a multicast protocol that is not part of an IP based network.

Resource Manager 18 controls the utilization and allocation of resources in the grid. Resource Manager 18 is responsible for controlling the resources that are advertised by the specific Service Agent 14 of the host device. As a result, Resource Manager 18 must resolve conflicts in the names of resources and must update the status of its resources in a timely manner. Resource Manager 18 also resolves a specified identifier to the defined resource. Resource Manager 18 may handle payment when a specific service request has been fulfilled, and may handle quality of service (QoS) issues including establishing failure mechanisms for the resources. Resource Manager 18 may also offer additional mechanisms for authentication and authorization of potential users of a particular resource. These mechanisms may be built into the resource sharing protocols or be ancillary to the ADRC architecture. Resource Manager 18 must further provide the characteristics of each resource, such as the status/availability of that resource, its name, and type. Resource Manager 18 must avoid scheduling conflicts and must reclaim resources provided to a specific device once that device leaves the network. Resource Manager 18 must additionally accommodate heterogeneous devices.

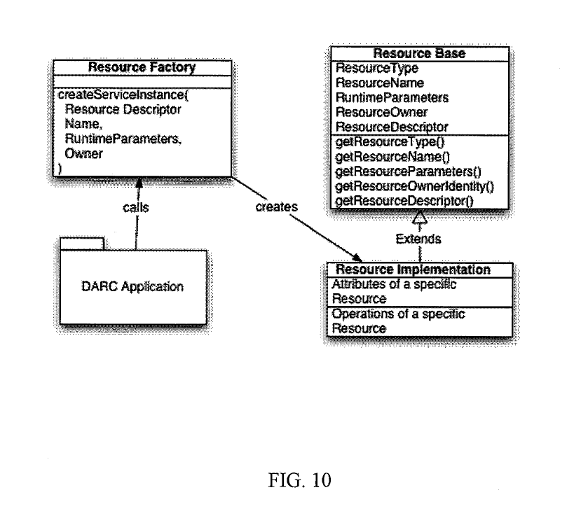

Referring to FIG. 9, Resource Manager 18 controls interfacing among devices. If device A 56 obtains general information about resources provided by device B 58 through the discovery protocol of Service Agent 14, then to obtain specific information about an available resource, device A 56 must first register with Resource Manager 18 of device B. Resource Manager 18 may be responsible for authenticating and authorizing the user of that device for accessing the specific resource. A user may be authenticated based on information such as their organizational affiliation, their functional role(s) in those organizations, the type of information requested, and the credentials of the user. If the user is authenticated for utilizing that resource, then the user is registered for that resource, and detailed information about that resource is provided to the user. Resource Manager 18 also allocates the resource to that user, and updates information concerning the resource. Referring to FIG. 10, Resource Manager 18 also provides instantiation of a resource in ADRC 10.

ADRC 10 may provide a charging and pricing mechanism for ADRC-based applications. Applications in ADRC 10 need flexible charging and pricing mechanisms when resources are shared across peers. A significant challenge in validating transactions in a wireless grid is the need for a trusted third party peer who validates every transaction that takes place. However, invoking trusted third parties when numerous transactions are taking place simultaneously is time-consuming and issues such as scalability must be addressed.

One solution is to use signed tokens present locally in each peer might [MMAPPS] contain accounting information validated between the peers involved in the transaction. Pricing of a resource can be expressed as a quantitative measure of signed tokens which peers store locally. Upon negotiation between peers for a resource to be shared, the resource requester peer will send the price of a resource in measure of tokens to the resource provider peer which is then approved for usage by the requester peer upon completion of usage of the resource. Hence, tokens that are transferred cannot be used unless they are approved.

Distributed audio recording applications may be based on ARDC 10. The basic concept for audio recording is the definition of two types of resources; recorders and mixers. A recorder is a resource that can record audio and send it out over the network. The requirements for a device that shares a recorder resource are network connectivity, in order to share the audio, and a microphone or other audio input, used to capture the audio. The device is not required to have enough storage to store the captured audio, but it may require storage to buffer the audio while it is getting sent to a mixer.

A mixer is a resource that can take two or more recorders and combine the audio into a “mixed” output stream. The combination of audio streams is based on using a method of synchronizing the audio streams at a certain point in order to have the final product be intelligible. The output from the mixer can either get sent back to all of the recorders who participated in the distributed recording (assuming that they have enough storage to hold the mixed audio,) or it can get a token (probably a URL and password) that can be used to retrieve the mixed audio at a later time. There is also a mechanism for devices that act as recorders to retrieve the individual audio streams from other recorders involved in the collection.

ARDC 10 may also be used for distributed screen sharing application. In this context, a display (monitor, projector, TV, etc.) is a resource, which can be utilized by any number of devices. For example, a business meeting may include several people who need to present using a projector. ARDC 10 enables them to share (via the single machine which is connected to the projector) their presentations. When a machine is granted access to use the display resource, its screen is sent over the network and displayed on the projector. In this manner, only a single machine has to be physically connected to the projector, and other people can display their screen on that shared projector without physically connecting.

ADRC 10 can be used to more easily create new applications (in comparison with alternative approaches) that take advantage of resource sharing between mobile, nomadic, and fixed devices. ADRC 10 can also be extended in the future to add new capabilities such as enhanced security, integration with traditional forms of distributed computing, and accounting schemes to allow for micro-transactions for the use of shared resources. The applications range from business, entertainment, emergency, health, and homeland and national security.

What is claimed is:

1. An architecture for a wireless grid network, comprising:
a resource descriptor for defining a resource participating in said network;
a service agent interconnected to said resource descriptor for publishing said resource to said network;
a session manager interconnected to said service agent for establishing a session between a wireless device participating in said network and said resource; and
a resource manager interconnected to said session manager, said service agent, and said resource descriptor for controlling the session between said wireless device and resource.

2. The architecture of claim 1, wherein said resource descriptor defines said resource using the name of said resource, the owner of said resource, the status of said resource, and the location of said resource.

3. The architecture of claim 2, wherein said service agent periodically receives updates from said resource manager about said resource.

4. The architecture of claim 3, wherein said resource manager includes user credentials for authentication of said wireless device.

5. The architecture of claim 4, wherein said resource manager allocates a charge to said wireless device based on the use of said resource by said wireless device.

6. The architecture of claim 1, wherein said resource descriptor establishes a protocol for use by said service agent, said session manager, and said resource manager.

7. The architecture of claim 6, wherein said protocol comprises a language selected from the group consisting of Abstract Syntax Notation One (ASN.1), Extensible Markup Language (XML), and Web Service Definition Language (WSDL).

8. A method of controlling a wireless grid network, comprising the steps of:
defining a resource participating in said network;
publishing said resource to said network;
establishing a session between a wireless device participating in said network and said resource; and
controlling the session between said wireless device and resource.

9. The network of claim 8, wherein the step of defining said resource comprises naming said resource, identifying the owner of said resource, identifying the status of said resource, and identifying the location of said resource.

10. The network of claim 9, further comprising the step of periodically updating the publication of said resource.

11. The network of claim 10, further comprising the step of authenticating said wireless device.

12. The network of claim 11, further comprising the step of charging for the use of said resource by said wireless device.

13. The network of claim 12, further comprising the step of establishing a protocol for said network.

14. The network of claim 13, wherein said protocol comprises a language selected from the group consisting of Abstract Syntax Notation One (ASN.1), Extensible Markup Language (XML), and Web Service Definition Language (WSDL).

15. A wireless grid network, comprising:
a wireless device participating in said network;
a resource descriptor for defining a plurality of resources participating in said network according to a predetermined protocol;
a service agent interconnected to said resource descriptor for locating said resources participating in said network and publishing information about said resources to said network;
a session manager interconnected to said service agent for establishing a session between said wireless device and any of said resources at the request of said wireless device; and
a resource manager interconnected to said session manager, said service agent, and said resource descriptor for authenticating said wireless device, controlling the session between said wireless device and said resources, and charging said wireless device for the use of said resources.

16. The network of claim 15, wherein said resource descriptor defines said resources using the names of said resources, the owners of said resources, the status of said resources, and the locations of said resources.

17. The network of claim 16, wherein said resource manager periodically updates said service agent about said resources.

18. The network of claim 17, wherein said resource manager includes user credentials for authenticating said wireless device.

19. The network of claim 18, wherein said predetermined protocol comprises a language selected from the group consisting of Abstract Syntax Notation One (ASN.1), Extensible Markup Language (XML), and Web Service Definition Language (WSDL).

20. The network of claim 19, wherein payment for the use of said resources is accomplished by a token exchange system.
